(19) United States
(12) Patent Application Publication
(10) Pub. No.: US 2021/0163111 A1
(43) Pub. Date: Jun. 3, 2021

(54) ELECTROMOTIVE DRIVE DEVICE AND A METHOD FOR OPERATING SUCH AN ELECTROMOTIVE DRIVE DEVICE

(71) Applicants: W & D INNOVATIONS B.V., s'Hertogenbosch (NL); TRIPLE D B.V., Drunen (NL)

(72) Inventor: Maikel LAMBREGTS, s'Hertogenbosch (NL)

(73) Assignees: W & D INNOVATIONS B.V.; TRIPLE D B.V.

(21) Appl. No.: 17/106,058

(22) Filed: Nov. 27, 2020

(30) Foreign Application Priority Data
Nov. 28, 2019 (DE) 10 2019 132 275.8
Jan. 20, 2020 (DE) 10 2020 101 237.3

(51) Int. Cl. B63H 21/17; H02K 5/04; H02K 9/00; B63H 1/02; B63H 21/38; B63H 21/36; B63H 21/21; G05D 1/00

(52) U.S. Cl. CPC B63H 21/17; H02K 5/04; H02K 9/00; B63H 1/02; B63H 2021/216; B63H 21/36; B63H 21/21; G05D 1/0011; B63H 21/383

(57) ABSTRACT

An electromotive drive device for a floatable device includes an electric motor operable by means of a separate power supply module with an energy accumulator, an electronic open-loop/closed-loop control unit and a remote control. The electric motor is within a housing connected to a drive propeller, which at least partially is surrounded by a protective device connected to the housing via connecting supports. The housing has an upper housing part and a lower housing part connected to each other by at least one releasable connection. The housing includes an elliptical bow, the end thereof transitioning into an essentially circular diameter with relative dimensions being a sum larger than an end of the housing with a projection opposite the bow. The housing in the lateral area behind the diameter is provided with intake openings for cooling water to flow inward. The cooling water can exit via outlet openings provided in the connecting supports. An operating method for the drive device includes an electronic open-loop/closed-loop control unit with an information processing unit. The drive ensures energetic use of the power supply module by reducing power while considering a travelled distance or travel time of the floatable device.

The invention relates to an electromotive drive device for a floatable device, preferably a float tube, with a drive by means of an electric motor, which is operable by means of a separate power supply module, an open-loop/closed-loop control and with a remote control, wherein the electric motor is disposed within a housing and is connected to a drive propeller outside the housing, which drive propeller, at least in areas, is surrounded by a protecting device, which is connected to the housing via connecting supports. Furthermore, the invention relates to a method for operating an electromotive drive device of the aforementioned species.

An electro-mechanical drive for a floatable device, which is employable in sport fishing, is known from the EP 3 257 741 A1. The drive includes a motor, the drive axis thereof being connected to a drive propeller.

The DE 84 01 738 U1 describes a drive apparatus with a propeller, which offers the option to make motor-less watercrafts drivable by means of the propeller emerging into the water. Upon reaching the desired location, the propeller is lifted again out of the water.

With the EP 2 824 027 A1 a boat drive unit is made public, which includes a self-contained liquid cooling system, the liquid thereof being contained in a closed interior space. The interior space is formed by means of a cylindrical exterior surface of a cylindrical motor housing section of the drive unit for exchanging thermal energy between an electric motor, which is disposed therein. The interior space of the self-contained liquid cooling system is partially delimited by a shell structure of the drive unit in such a manner that the liquid in the interior space is in direct contact with the shell structure. Thus, exchange of thermal energy with the water of the environment is possible.

An electro-mechanical drive for a floatable device, which is employable in sport fishing, is disclosed in the EP 3 257 741 A1. A narrow unilateral mount is connected to the casing, the free end of the mount ends at a mounting foot for the connection to a mount, which is disposed at the floatable device; and furthermore, at the casing, a protective device is starting for the drive propeller.

The object of the invention is to create an electromotive drive device for a floatable device, the configuration thereof being provided for an energy-saving application in view of optimizing the use of the available energy.

An electromotive drive device according to the features of claim 1 achieves the object of the invention. Furthermore, the features of claim 15 claim a method for operating an electromotive drive device with the indicated features. In this case, the dependent claims following respectively the main claims, represent a further configuration of the inventive idea.

Sport fishing and therefore recreational fishing is gaining increasing commercial significance. So as to reel in a successful catch, in addition to fishing equipment also other important prerequisites are required, for example in the form of inflatable boats. Such boats, also known as belly boats or float tubes, are advantageous in that sport fishing is not limited to the shores of bodies of water. In this case, a float tube is substantially smaller than a normal rubber boat and allows the angler to freely move on the surface of the water and simultaneously practice sportive fishing with both hands. The structure of the float tube is specifically tailored to the angler, as the angler sits in the float tube and his/her feet hang in the water. Forceful paddling moves with the legs will move the boat on the water surface and steer it in the desired direction for practicing sportive fishing. Said locomotion requires a lot of force and in particular strong currents in flowing waters cause issues. Employing uniquely said option of locomotion considerably limits the use of the floatable device. This is what the inventors understood without a doubt, and therefore they came up with employing electromotive drive devices.

Such an electromotive drive device in the shape of a drive is located completely underneath the water surface and is affixed to the underside of the float tube or to the underside of another floatable device. Said placement is essentially advantageous, in particular for sport fishing, as activating the drive propeller does not create any mentionable waves, respectively does not develop any noise, which could cause the fish stocks to leave said region. Another advantage of such an electromotive drive device is found in quickly and easily reaching more remote fishing grounds.

Having a float tube or the like equipped in such a manner with an electromotive drive device thus allows for employing navigational sounding for being able to find fishing stocks, as the fish's air bubbles deliver very well recognizable echos. For this reason echo sounding delivers the angler important information on the number of fish in a region, respectively also under his boat, float tube or the like.

When employing an electromotive drive device together with a floatable device, herein in particular a float tube, the energy consumption is of decisive importance for the most economical use of the available energy. Only an energy accumulator can deliver the energy for operating an electromotive drive device on the water. With the intention of economically using said available energy to the greatest possible advantage, there are two major topics to consider, on the one hand, the design of the electromotive drive device and, on the other hand, providing an energy management, so that the angler returns in any case to his/her start point.

This is why the shape design of the drive device is of particular importance. In this case, flow-optimized drop-shaped embodiments of the housing have proven particularly advantageous, for example in an elliptical, rounded shaping on all sides, in addition to a good trimming. The end of said shape formation represents the widest location of the housing, then subsequently the proper housing shape narrows. The ratio of the bow in the frontal area to the length crucially also determines the speed of the drive device. The shape of the bow draws the water, which is displaced by the drive device, at a higher speed under the drive than the surrounding water, what decisively contributes to a reduced water resistance. The corresponding embodiment of the housing, which consists of an upper part and a lower part, intends to prevent turbulent flow around the drive device, because, on the one hand, turbulent flow would result in higher energy input, and moreover could also contribute to chase off the fish stock.

An energy efficient quantifiable prevention of energy losses due to the exterior shape design of the drive device can decisively contribute to being able to reasonably employ the available energy stored in the energy accumulator. In particular, this means energy benefits for decreasing primary or final energy input.

A further very decisive contribution to reducing the energy input when operating the drive device is found in that a motor, which is embedded within the two housing parts and kept therein, and to which the drive propeller is attached, is cooled at best by the surrounding water. This is realized through lateral intake openings, into which the cooling water can flow. Within the entire housing, the cooling water flows are subdivided into sections so that in addition to an optimum cooling, the sectioned cooling water flows combine again to an overall flow in the following, which exits at connecting supports via outlet openings and thus can contribute to assisting the drive.

At one portion of the housing, the two-part housing of the drive device has a mount, which can be releasably mounted to the floatable device underneath the water line via a connection.

For example, as a protection, the drive propeller can be provided with a ring shaped protective device in order to keep any items in the water away from the drive propeller. In a preferred embodiment, it is possible for the protective device to extend not completely circularly or ring-shaped around the drive propeller, but only partially. This is advantageous in that the flow resistances altogether can be reduced. Such an embodiment of partially mounting a protective device is then realized at the lower part so that protruding materials present in the navigational water cannot get into the area of the drive propeller.

Likewise, riding the float tube or the like combined with the drive device can be disturbed in that growth of plants, which in particular happens extensively during some seasons in bodies of water, could block the drive propeller. Such a blocking is very problematic, because the drive device is located underneath the floatable device. In such case, the angler can only return to the start point or steer to other shore regions, what s/he can only accomplish by working the leg muscles, in order to subsequently free the drive propeller from the plants. The above scenario cannot happen with the embodied structure of a particularly designed transition between the housing of the drive device and the connection of the drive propeller, because the structure is made such that vegetable matter cannot enter into said area any more. For this purpose, in a preferred embodiment, an overlapping conformation is provided at the housing with the upper housing part and the lower housing part thereof, which conformation at the end of the drive propeller is provided with a protruding area, which essentially is oriented to the side of the housing. Such a structure of so to say overlapping stationary housing parts and the rotating drive propeller protects the critical area against penetrating vegetable matter. One possible embodiment can be designed such that the end of a reception of the drive propeller includes a conical or straight course or the housing parts have a straight or conical course.

In a further preferred embodiment, it is also possible to employ seals in said area. Thus, a seal can be inserted between the stationary conformation of the housing and the end of the drive propeller. In such an embodiment, it is possible for the seal to be attached in the stationary conformation of the housing on the one side or else to be located on the exterior diameter of the end of the drive propeller.

An energy accumulator, for example in the shape of a lithium-ion accumulator, operates the electromotive drive device. Such an energy accumulator is located above the waterline on the float tube and is exchangeably connected to the drive device, which is located below the waterline, by means of a cable connector. The power supply from the energy accumulator to the drive device is controlled by a wireless and watertight manipulation element in the shape of a remote control. The remote control contains a sender/receiver device. The watertight power supply module likewise includes a transceiver device for communicating with the remote control. So that the owners/operators of several drive devices do not interfere with each other, the remote control can realize a change of the active transmitting channels. Such a remote control can be affixed to the body of the angler or optionally directly to the floatable device of the float tube. In addition to elements for activating the drive motor, the remote control can also include displays, which display the current charge state of the energy accumulator, for example. In addition to the current charge state of the energy accumulator, the display elements can also reveal other information to the user. This can be done with numerals, e.g. for the current motor performance in percentage, or else can be done with coloured displays. In particular, coloured displays are better seen on the water than numerals. Thus essentially, a color green can signal unrestricted operation, whereas a change from orange to the red area can display a certain risk area, respectively only a restricted functioning of the drive device. In this case, the functioning is determined at any point in time by the available power of the energy accumulator. At all times the maxim to be observed for the user of the drive device should be the return to a shore or to a coast. Furthermore, the remote control can be provided with a memory function, which stores a value of driven speed of the float tube, so as to continue driving at the same speed later. Likewise, the current rotational speed of the electric motor and also the power consumption of the drive device can be displayed.

The remote control can be equipped with an emergency shut-off switch, for example in order to switch-off the electric motor after the drive propeller is blocked, which can be displayed.

An open-loop/closed-loop control unit disposed within the receptacle includes an information processing unit, which performs permanent monitoring of the rationally available energy capacity. In addition to the travelled distance, such monitoring also includes the accumulated operating time of the drive device. Thereby, the motor runs automatically at the rotational speed according to the maxims of safe return to the shore. Thus, for example based on lower energy, also the open-loop/closed loop control unit can adapt the drive propeller to a reduced rotational speed, and thus adapt the speed.

In case of an undesired incident when employing the drive device, for example should the user not be able to operate the drive device any more, for example when s/he fell out of the float tube, an automatic forced outage of the entire drive device is triggered by a safety connection. Likewise, an emergency shut-off button is provided at the receptacle, so that the drive device can be shut-off at any time in case of failure or loss of the remote control or a hazard situation.

In a preferred embodiment, an electronic pulse-width modulation closed-loop control operates the open-loop/closed-loop control unit.

Employing the above-described electromotive drive device makes the use of the float tube or the like for the concerned angler a lot safer. The applicability is optimized as well, likewise the influence of atmospheric conditions can be addressed.

In a preferred embodiment, it is also possible that the person floating in the float tube on a body of water is able to modify the control of the drive by means of the remote control in that in addition to forward motion also backward motion can be performed. Also, when the float tube moves backwards, the speed is gradually adaptable to the requirements of the journey. Such bi-directional option, with the possibility of unrestrictedly travelling with the float tube in two travel directions with the help of the electro-mechanical drive device, is a particularity, because a float tube without drive device is only movable in forward direction. Thus, different fishing techniques can be practised without any problem, which do not only comprise the usual fishing operation. The drive device can be effectively employed as well as a brake in a targeted manner in both directions for dealing with too strong wind or too strong a current, which would cause drifting of the float tube away from the fishing spot. Also in case the fishing hook gets stuck in the subsoil or in case the person using the float tube in a side arm of the body of water, without the option of backward motion, would only be able to realize the change of the travel direction at great time expense, are situations in which controlling the drive device in both travel directions are of utmost importance. Obviously, also landing and departing is considerably easier with targeted changes of travel directions. Practising fishing, which otherwise is only reserved to large boats or vessels, namely pelagic fishing, can be performed with the combination of float tube and the inventive drive device.

In the following, the invention will be illustrated in more detail based on different exemplary embodiments in the drawings.

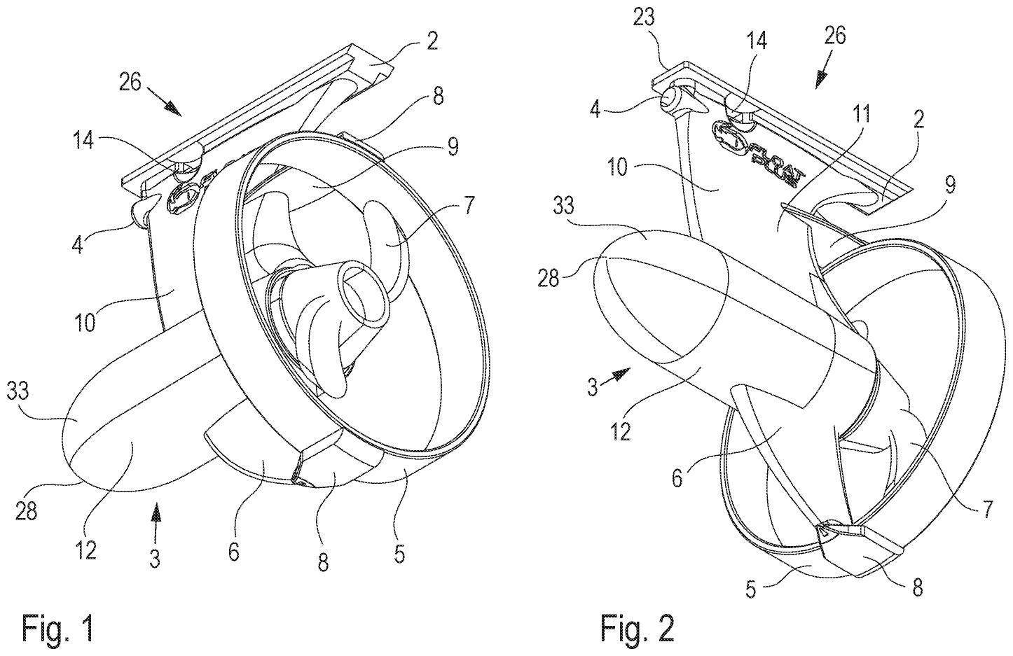

FIG. 1: A perspective illustration of a first preferred embodiment of an electromotive drive device;

FIG. 2: the same as FIG. 1, however, in a rear-sided view;

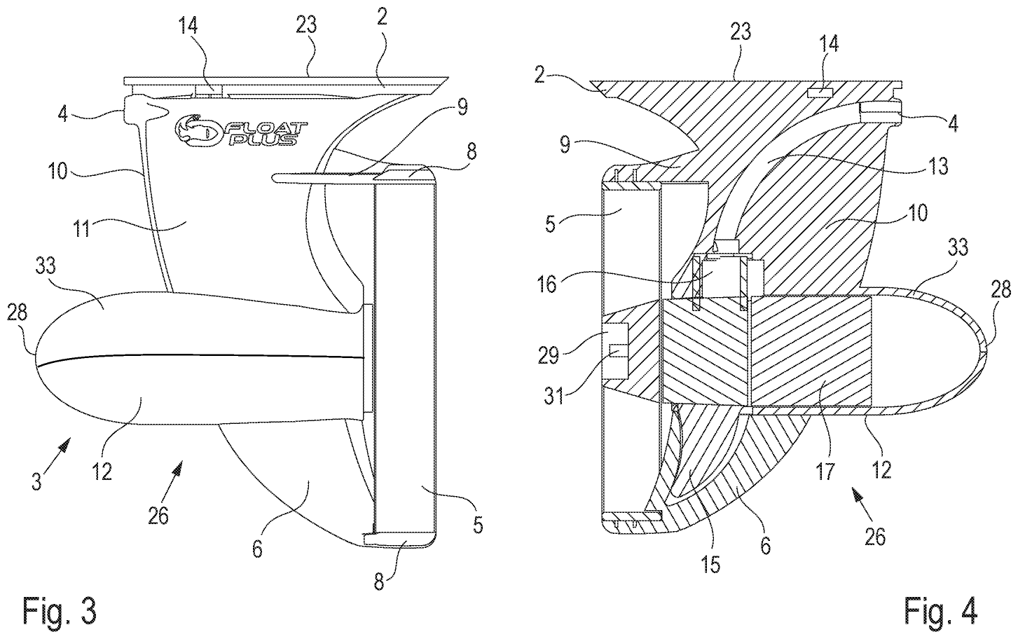

FIG. 3: the same as FIG. 1, however, in a lateral view;

FIG. 4: a drive device according to FIG. 1 in a sectional illustration;

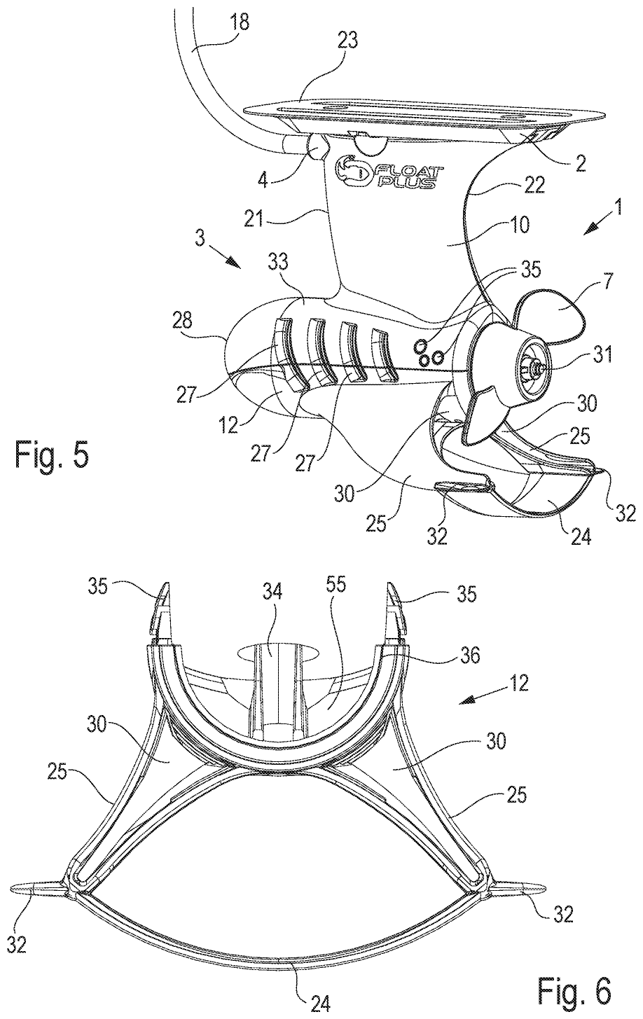

FIG. 5: a further preferred embodiment of an electromotive drive device in the perspective illustration;

FIG. 6: a front view of an upper housing part;

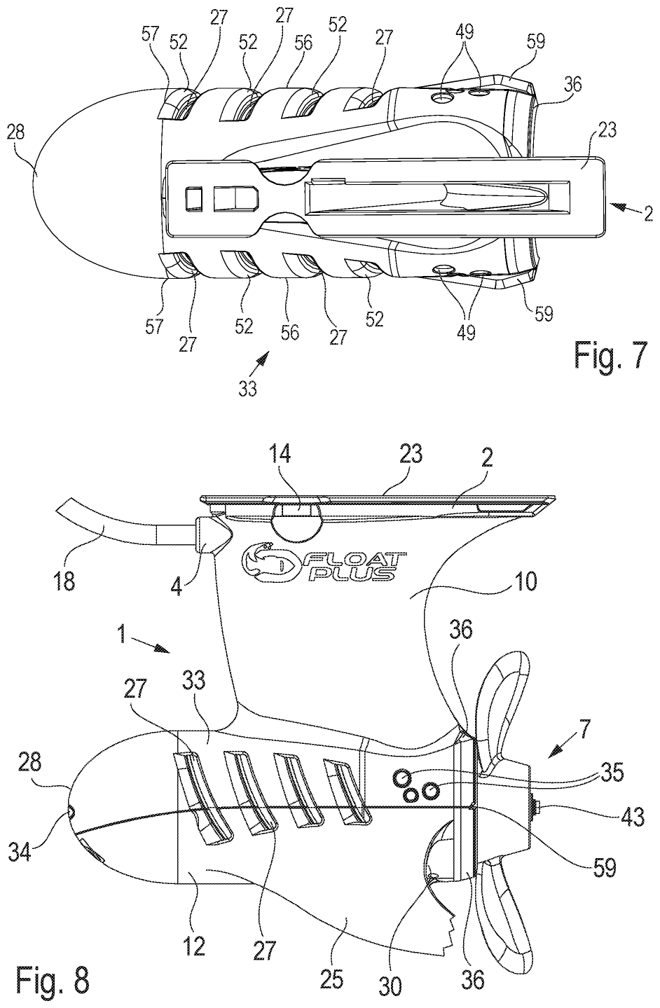

FIG. 7: a top view of a lower housing part;

FIG. 8: a partial illustration of the drive device according to FIG. 5;

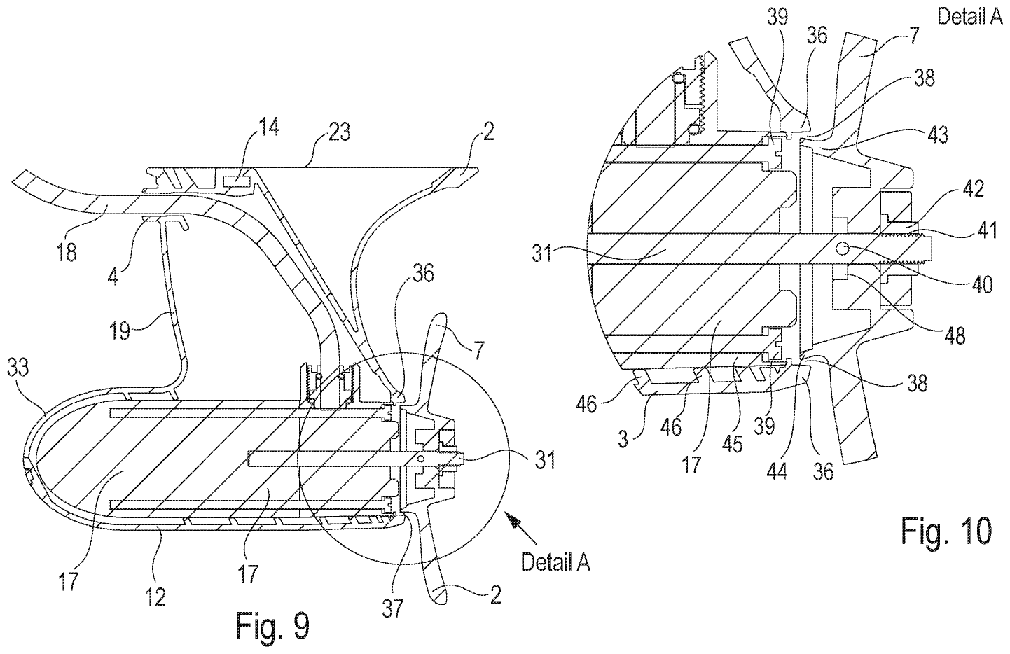

FIG. 9: a section of the drive device according to FIG. 8,

FIG. 10: a detailed view according to FIG. 9;

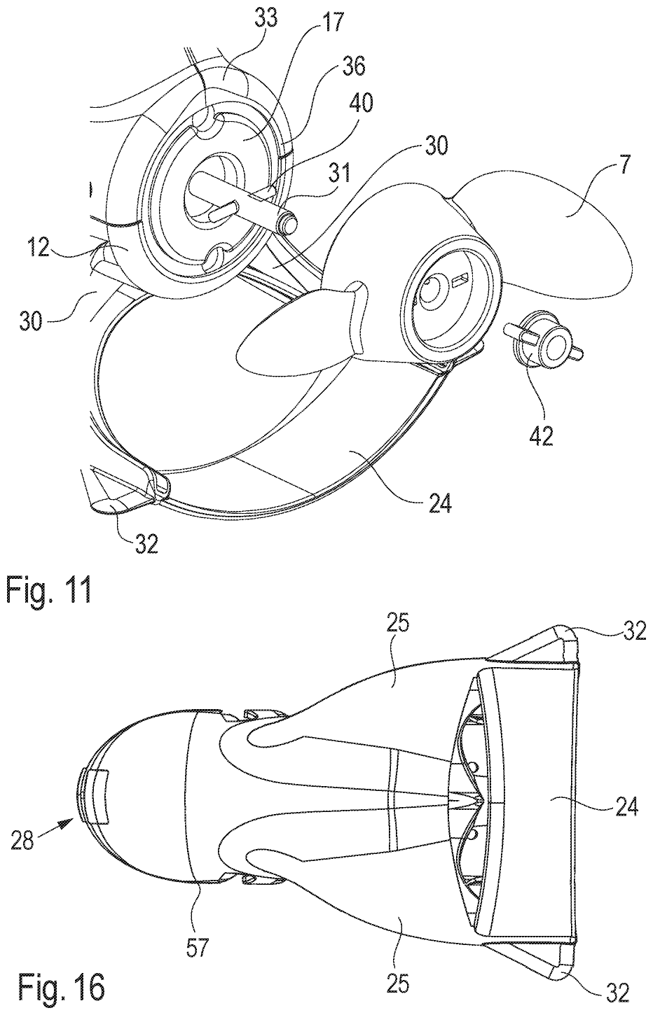

FIG. 11: a cutout illustration with mounting possibilities of a drive propeller;

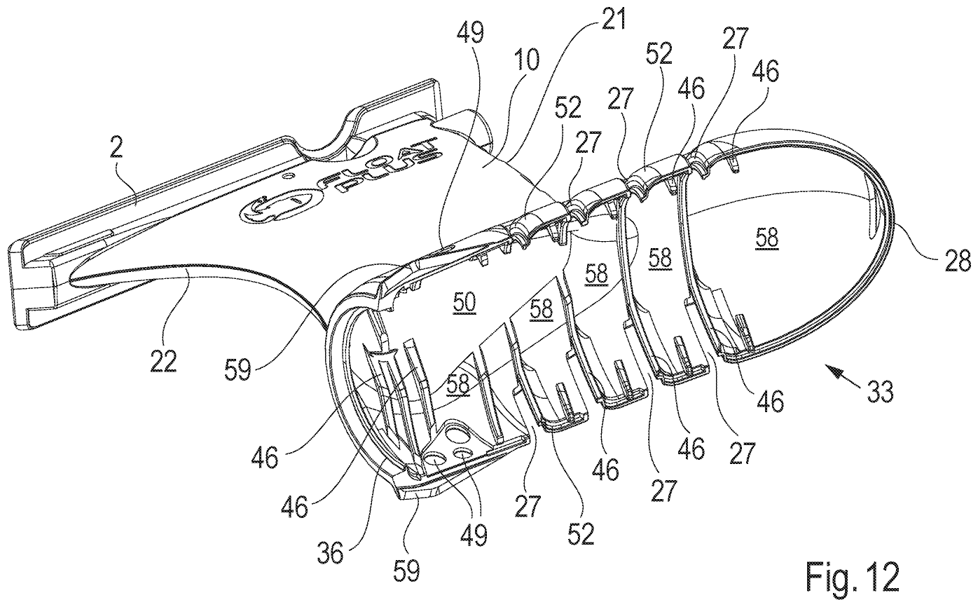

FIG. 12: a perspective illustration of the lower housing part;

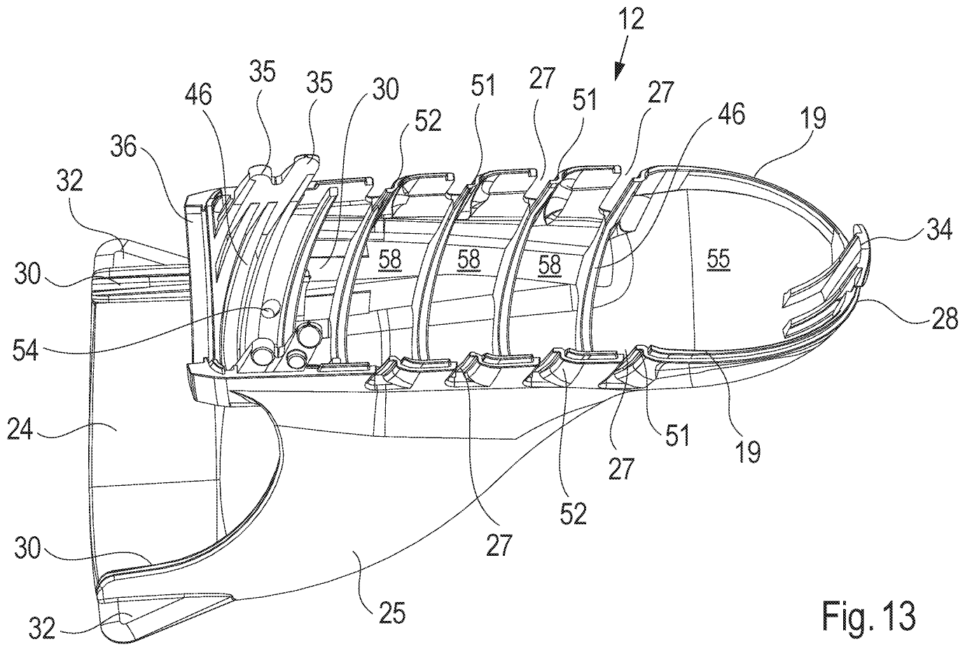

FIG. 13: a perspective illustration of the upper housing part;

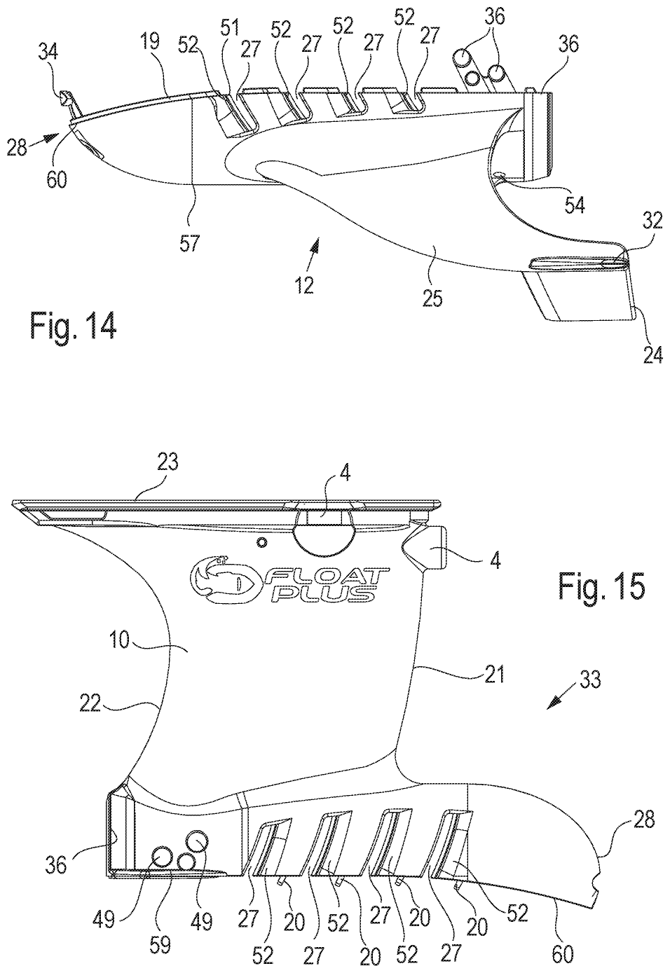

FIG. 14: a lateral view of the upper housing part;

FIG. 15: a lateral view of the lower housing part;

FIG. 16: the drive device in an underside view;

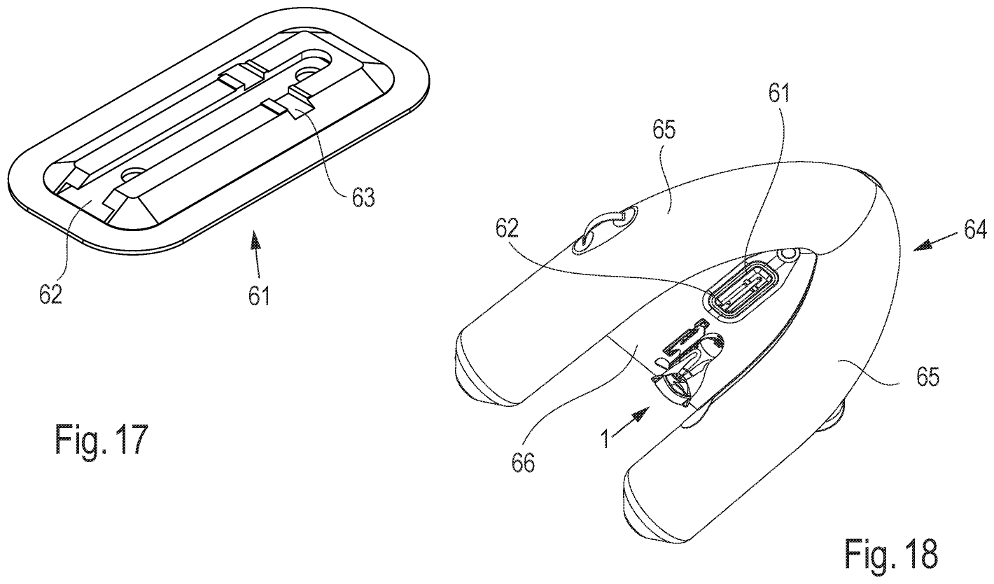

FIG. 17: a potential configuration of a mount;

FIG. 18: an application of a drive device underneath a float tube;

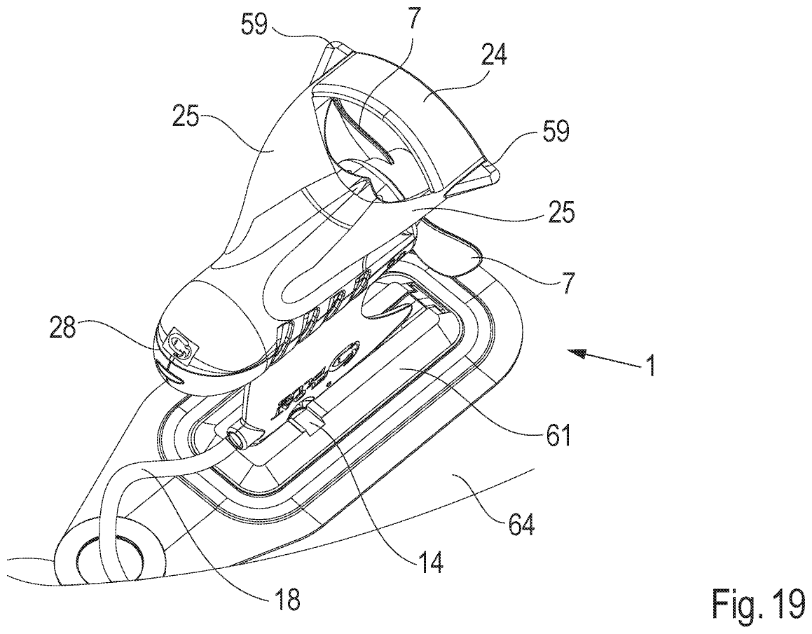

FIG. 19: an attachment of a drive device to a float tube;

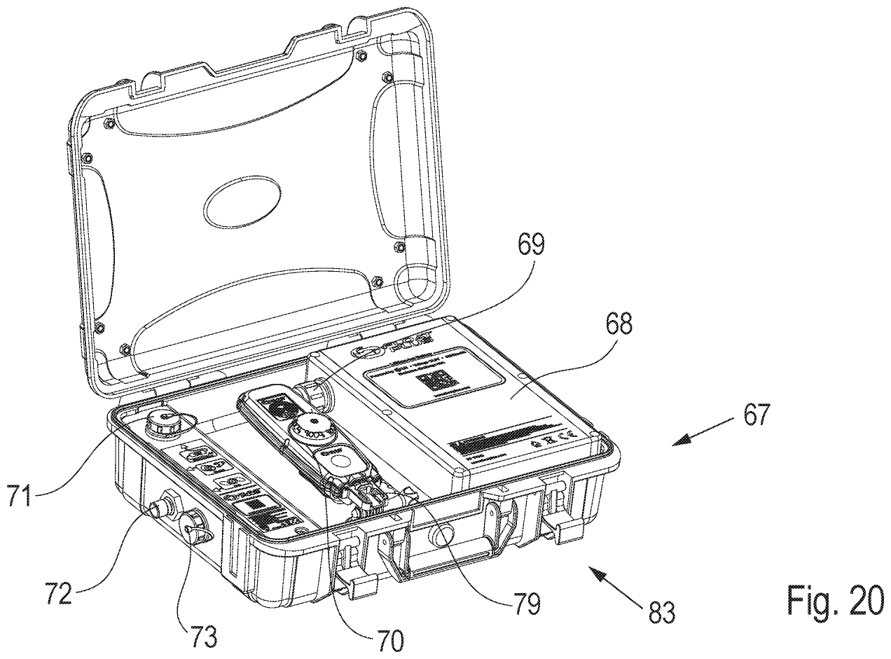

FIG. 20: a receptacle for operating the drive device;

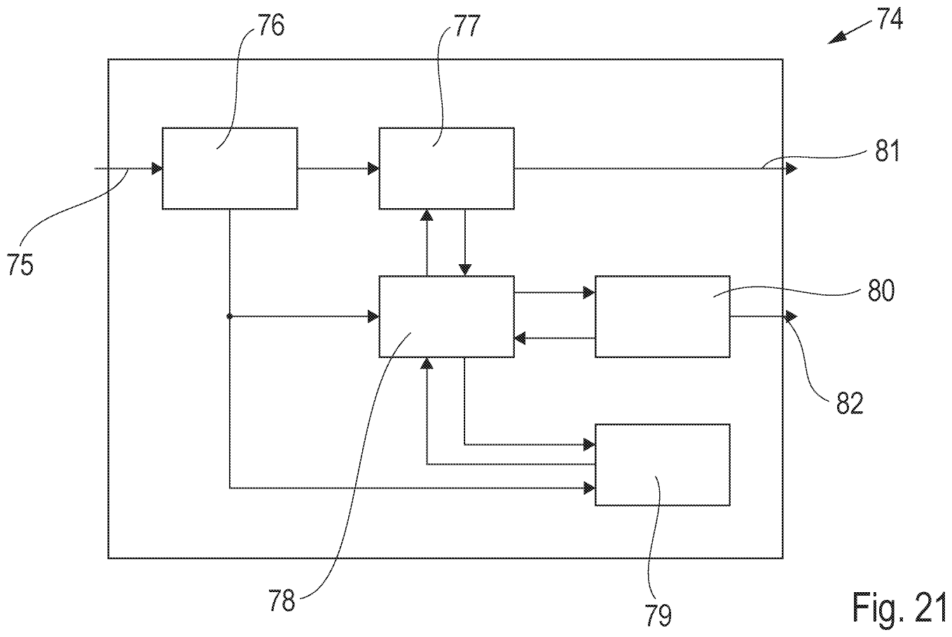

FIG. 21: a block diagram of an open-loop/closed-loop control unit.

FIG. 1 reveals a first preferred embodiment of a drive device with a drive 26. Starting at a mounting foot 2, a protruding mount 10 is provided, which is adjoined by a housing formation 3. In this case, the housing 3 consists of a lower housing part 33 and an upper housing part 12. A connecting piece 9, which transitions into a further connecting piece 8, which serves for stabilizing a protective device 5, is illustrated above at the upper housing part 12. In the same manner, in the lower area of the mount 8 as well, the connecting piece 9 with the connecting piece 8 is disposed at the protective device 5. In said embodiment, the protective device 5 is illustrated as a circular component, wherein the protective device 5 surrounds a drive propeller 7. The housing 3 is provided with intake openings 27 for cooling water to enter. A bow 28 is illustrated at the front side of the housing formation. Electric energy is supplied to the drive 26 via a power supply connector 4. Then, the mounting foot 2 includes a securing breakthrough 14, in order to be able to exchangeably mount the drive 26 to a floatable device, for example in the shape of a float tube or the like. This provision allows for using the drive 26 for various floatable devices, likewise transport is made easier.

In FIG. 2 represents the drive 26 in a perspective illustration from the rear. In this case, it becomes obvious that the mounting foot 2 can be embodied on the underside with a straight connecting surface 23 for attaching to a mount 61, which is revealed in FIG. 17. In this case, the mounting foot 2 is pushed into a laterally open reception 62 and is reliably secured in a simple manner via a depression 63 in conjunction with the securing breakthrough and a securing element.

The mount 10 has curved side lines 11, which in the flow-optimized embodiment thereof taper towards the drive propeller 7.

Said above-described embodiments according to the FIGS. 1 and 2 are again revealed in a lateral view of FIG. 3.

FIG. 4 represents a sectional illustration according to FIG. 3 through the entire drive 26. In said exemplary embodiment, an electric motor 17 with a gear, which is not identified in detail, is placed within the upper housing part 12 and the lower housing part 33. A rotation protection 15 is disposed at the gear, so that the installed electric motor 17 remains in the position thereof. A drive shaft 31, at which a drive connector 29 is placed, is located at the exit of the gear, which is not identified in detail. The non-illustrated blades of the drive propeller 7 are formed at the drive connector 29. The rotation protection 15 for the combination of electric motor 17 and gear engages within a connecting support 6. Within the mount 10 in continuation of the power supply connector 4 into a channel 13, an electrical connector is installed, which at the end side, includes a plug-in device 16 for the connection to the electric motor 17.

FIG. 5 reveals a further preferred embodiment of a drive 1 in a perspective illustration. Starting at the mounting foot 2 with the straight connecting surface 23 thereof, herein again, the mount 10 is formed. The power supply connector 4, which is connected to a cable connector 18, transitions into the mount 10. At a front side 21 of the mount 10, a rounding is formed, which ends in a rear side 22. The housing 3 with the upper housing part 12 and the lower housing part 33, to which the mount 10 is conformed, are retained in the position thereof by connections 35. The intake openings 27 for the entering cooling water for the electric motor 17 are illustrated laterally both in the upper housing part 12 and in the lower housing part 33. In this case, the intake openings 27 are illustrated as flow-optimized and following a rounding 52. The connecting supports 25, which on the underside lead into a rounded protective device 24, are conformed on both sides of the upper housing part 12. Oriented towards the drive propeller 7, the connecting supports 25 are provided with outlet openings 30 for the exiting cooling water.

According to the view of drawing 6, the upper housing part 12 is illustrated in a frontal view. Said illustration particularly clearly reveals that the outlet openings 30, provided in the connecting supports 25, are connected in a flow-optimized manner to an interior space 55 of the housing 3. Stabilizing sections 32, which lend the embodiment of the drive 1 a steady placement in the water, are conformed at the lower end of the connecting supports 25, laterally to the protective device 5.

In an individual illustration according to FIG. 7, the lower housing part 33 is illustrated in a view onto the connecting surface 23. Said illustration particularly clearly reveals that the bow 28 has an essentially elliptical bulge-like shape, which is configured all-around and which in the terminal area thereof has an essentially round diameter 57 towards the housing 3. The diameter 57 in the absolute dimensions thereof is greater than for example a protrusion 36, which is located in the area of the connection for the drive propeller 7. The intake openings 27 for the cooling water for the electric motor 17 are illustrated in an exterior wall 56 laterally in the lower housing part 33. As can be seen in the illustrations of the intake openings 27, starting at the exterior wall 56, a rounding 52 is illustrated, which ensures that the cooling water entering into the intake openings 27 does not create an turbulences and so that thereby no energy losses occur. Furthermore, bores 49 are provided in the lower housing part 33, which serve for stabilizing the housing parts 12 and 33 once they are assembled. Moreover, with the intention to allow for separating the upper housing part and the lower housing part, for example the lower housing part 33 is provided with lateral projections 59.

FIG. 8 represents once more an overall view of the housing 3 of the drive 1. In this case, the upper housing part 12 is exchangeably connected to the lower housing part 33, on the one hand via the connections 35 and, on the other hand, in the area of the bow 28 via mounts 34. FIG. 8 likewise reveals that the drive propeller 7 with the reception 43 thereof is located closely at, respectively in the housing 3. The entire housing 3 is illustrated once more in a sectional illustration according to FIG. 9. The electric motor 17 is embedded in a clamping manner within the upper housing part 12 and the lower housing part 33 without any additional attachments. The connection to the electric motor 17 is ensured via the cable connector 18.

With the intention to clarify the housing structure, which prevents blocking the drive propeller 7 the housing 3 by means of vegetable matter, it is referred to the detail A of FIG. 10. The reception 43 of the drive propeller 7 enters between the projection 36, which is located in the lower housing part 33 and the upper housing part 12. Especially, said configuration of the projection 36 in conjunction with the reception 43 creates only a very narrow gap 38 between the stationary projection 36 and the reception 43 rotating on account of the drive shaft 31. As one end 44 of the reception 43 is located behind the end of the projection 36, the quasi conical formation of the gap 38 becomes so small that vegetable matter or the like in said area cannot cause any arrest of the drive propeller 7.

A pin 40, which engages into a recess 48 of the reception 43, passes through the drive shaft 31. On account of said embodiment, the reception 43 with the drive propeller 7 is torque-proof attached on the drive shaft 31. A thread 41 is located at the end of the drive shaft 31, onto which thread a nut 42 is screwed for securing the reception 43. For example, the electric motor 17 is secured with screw connections 39 to a gear, which is not designated in detail. FIG. 11 reveals once more that simple mounting of the drive propeller 7 is possible.

While the preceding drawings essentially described the exterior area of the housing, FIGS. 12 and 13 refer to the area, in which the electric motor 17 is reliably retained between the upper part 12 and the lower housing part 33 solely by the connecting forces via the mount 34 and the bores 49 with the connections 35. For positioning the electric motor 17, webs 46 in the housing 3, and thus both in the lower housing part 33 and in the upper housing part 12, retain the essentially round housing. The webs 46 have another task, and namely channeling the cooling water flowing in through the intake openings 27 by means of the sections 58, which are located between neighboring webs 46. On account of the sections 58, the cooling water is directly guided into the exterior areas of the electric motor 17. After entering via the intake openings 27, the cooling water is guided further in such a manner that it cannot remain laterally within the housing 3, because in conjunction with the sections 58, the present cooling water is directly guided to the outside of the housing 3 via the outlet openings 30 next to the drive propeller 7.

With the intention to prevent turbulences of the entering cooling water, projections 51 with a rounding 52 are provided in the area of the intake openings 27. The projection 51 is conformed to the webs 46. With said formation, the entering cooling water is guided into the housing 3 in such a manner that the electric motor 17 experiences a very efficient cooling. An open free space 50 is provided in the rear area of the lower housing part 33. Furthermore, discharge bores 54 are located in the interior space of the housing 3 for the available cooling water to drain.

FIG. 14 illustrates the upper housing part 12 in a lateral view, wherein said illustration particularly represents the course of a separating line 60 between the upper housing part 12 and the lower housing part 33, which is shown in FIG. 15. The course of the separating line 60 is not straight, but has a curved course, which at the upper housing part 12 has its lowest point in the area of the bow 28. Said measure also prevents turbulences of the flowing surrounding water laterally at the housing 3, when riding the float tube 64. When following the course of the separating line 60 in the interior area, i.e. towards the interior space 55, a surrounding projection 19 is provided, in the area of the separating line 60 at the lower housing part 33, a corresponding recess is provided, respectively pins 20 or pins, which ensure a precise positioning between the lower housing part 33 and the upper housing part 12. However, when operating the drive device, even the slightest turbulence draws additional energy from the power supply module 67.

FIG. 16 reveals the flow-efficient embodiment of the exterior shape of the housing 3 with the bow 28 and the point of the dimension expansion at the diameter 57 of the housing 3 in the longitudinal extension thereof. Said shape design, when riding the float tube, ensures that waves or wave movements will not have any lateral contact with the housing 3 or only very little contact. Thereby, ensuring efficient energy use.

FIG. 18 shows an exemplary application of the drive 1 at a carrier surface 66 of a float tube 64. In this case, the carrier surface 66 is located between lateral bulges 65. In this case, the mount 61 with the reception 62 thereof is placed on the carrier surface 66 such that subsequently the drive 1 is pushed into the reception 62 and then can be secured at that location. FIG. 19 shows said placement within the mount 61. Once the mounting foot 2 is inserted into the reception 62, subsequently a non-illustrated securing element is inserted via the securing breakthrough 14, such that the drive 1 is firmly seated.

The cable connector 18 supplies the drive with electric energy from the power supply module 67, which can be seen in FIG. 20 in a preferred embodiment. The power supply module 67 is located in a receptacle 83 for this purpose, which is transportable and is closable in a watertight manner. When using the power supply module 67, a drive connector 73 by means of the cable connector 18 can supply the drive 1, 26 with electric energy. An energy accumulator 68 is provided for this purpose within the receptacle 83 and can be optionally guided to the drive connector 73 or else to a charge connector 71 via an electrical connector 69. The charge connector 71 allows for recharging the energy accumulator 68.

Moreover, a remote control 70 in the standby position thereof is inserted into the receptacle 83 by means of a plug-in connection. Said plug-in connection is simultaneously designed as a power supply 79 for the remote control in the standby position thereof. When in use, i.e. when employing the power supply module 67, the remote control 70 is removed from the holder thereof, and, based on the sender and receiver device 80 contained therein, it can communicate with a non-illustrated sender and receiver device within the receptacle 83. In this case, it is possible for the remote control 70 in particular to gradually adapt the speed, as well as the direction of movement of the drive 1, 26 can be changed. A change of direction, i.e. a sternway is given when currents have made the float tube 64 drift into an area, from which it has difficulties to manoeuvre its way out. Furthermore, the remote control 70 allows for reading the charge state of the energy accumulator 68. Simultaneously, the charge state is an indicator or characteristic for having travelled a certain distance and/or a certain period of time. Said parameters are permanently calculated via an open-loop/closed-loop control unit 77. Said permanent calculation ensures that the available energy of the energy accumulator is always measured in such a manner that the angler can safely return to a shore or a coast with the energy still available in the energy accumulator 68.

The open-loop/closed-loop control unit 77 is illustrated in a block diagram 74 according to FIG. 21. A power supply 76 supplies electric energy to the open-loop/closed-loop control unit 77 via an energy supply connector 75. The same supply is established to a processor 78 and to the power supply connector 79 for the remote control 70. The processor 78 mutually communicates with the open-loop/closed-loop control unit 77 and, based on the parameters, which the provided data processing unit receives from outside, calculates the behavior of the open-loop/closed-loop control unit 77 such as to correspondingly energize the electric motor 17 via a motor connector 81. The processor 78 likewise communicates with a sender and receiver unit 80, which also has a connection 82 to the remote control 70 within the receptacle 83.

As shown in the exemplary embodiment of a preferred embodiment of both the drive 1 and the open-loop/closed-loop control unit 77 in conjunction with the power supply module 67, energy-saving use in terms of optimizing the available energy is possible with the particularly designed housing 3 in conjunction with an efficient cooling.

### REFERENCES

1 drive
2 mounting foot
3 housing
4 power supply connector
5 protective device
6 connecting support
7 drive propeller
8 connecting piece
9 connecting piece
10 mount
11 side line
12 upper housing part
13 channel
14 securing breakthrough
15 rotation protection
16 plug-in device
17 electric motor
18 cable connector
19 projection
20 pins
21 frontal side
22 rear side
23 connecting surface
24 protective device
25 connecting supports
26 drive
27 intake opening
28 bow
29 drive connector
30 outlet opening
31 drive shaft
32 stabilizing section
33 lower housing part
34 mount
35 connection
36 projection
37 recess
38 gap
39 screw connection
40 pin
41 thread
42 nut
43 reception
44 end
46 web
47 free-cut
48 recess
49 bore
50 free space
51 projection
52 rounding
53 break-through
54 discharge bore
55 interior space
56 outside wall
57 diameter
58 section
59 projection
60 separating line
61 mount
62 reception
63 depression
64 float tube
65 bulge
66 carrier surface
67 power supply module
68 energy accumulator
69 connector
70 remote control
71 charge connector
72 emergency-off button
73 drive connector
74 block diagram
75 energy supply connector
76 power supply
77 open-loop/closed-loop control unit
78 processor
79 power supply
80 sender/receiver unit
81 motor connector
82 connection
83 receptacle

1. An electromotive drive device for a floatable device, preferably a float tube, with a drive, which includes an electric motor, which is operable by means of a separate power supply module with an energy accumulator, an electronic open-loop/closed-loop control unit and a remote control, wherein the electric motor is disposed within a housing and outside the housing is connected to a drive propeller, which at least partially is surrounded by a protective device, which is connected to the housing via connecting supports, wherein the housing consists of an upper housing part and a lower housing part, which are connected to each other by means of at least one releasable connection, wherein the housing includes a bow in an enveloping elliptical embodiment, the end thereof transitioning into an essentially circular diameter, the relative dimensions thereof as a sum being larger than an end of the housing with a projection opposite the bow, and in that the housing in the lateral area behind the diameter is provided with intake openings for cooling water to flow in when operating the drive, which cooling water, after sectioned contact with the exterior termination of the electric motor while assisting the driving, can exit again via outlet openings, which are provided in the connecting supports.

2. The drive device according to claim 1, wherein the connection between the upper housing part and the lower housing part follows a curved separating line.

3. The drive device according to claim 1, wherein the intake openings respectively at the entry are provided with roundings, which end in projections, which at the end side are oriented towards the electric motor and simultaneously within the upper housing part and the lower housing part transition into corresponding webs, such that between two neighboring webs respectively one section is created, wherein each one of the individual sections includes a connection to the two outlet openings.

4. The drive device according to claim 1, wherein there is a gap between the projection and a reception of the drive propeller, which gap after having mounted the drive propeller with the reception covers, at least in one area, an end of the reception such that a portion of vegetable growth located in the water surrounding the installed drive cannot result in blocking the drive propeller, when the drive propeller rotates.

5. The drive device according to claim 1, wherein the end of the reception has a conical or straight course or the projection has straight or conical course.

6. The drive device according to claim 1, wherein, on the inside, the projection includes a surrounding sealing element or in that a sealing element essentially closes the gap.

7. The drive device according to claim 1, wherein the electric motor includes an essentially round exterior termination, which is retained in the position thereof between the upper housing part and the lower housing part between the webs.

8. The drive device according to claim 1, wherein a mount is connected to the lower housing part, wherein the free end of the mount transitions into a mounting foot, which serves for the releasable connection to a mount disposed at the floatable device, which mount includes a reception, which contains a complementary embodiment of the mounting foot, wherein, for securing the drive inserted into the mount, the mounting foot or the mount includes a securing breakthrough, which corresponds to a depression in the mount.

9. The drive device according to claim 1, wherein the housing with the mount and the protective device consist of plastic material.

10. The drive device according to claim 1, wherein the power supply module is accommodated in at least one water-tight receptacle, in which likewise are contained the open-loop/closed-loop control unit and the remote control and a sender/receiver unit for communication with the remote control, and a mount with a connector to the power supply, and in that the receptacle in addition to a drive connector and a charge connector also includes an emergency shut-off button, which is operable from outside the receptacle.

11. The drive device according to claim 1, wherein the energy accumulator is embodied as an accumulator, preferably as a lithium-ion accumulator, and is optionally accommodated within a water-tight receptacle.

12. The drive device according to claim 1, wherein the power supply module with the open-loop/closed-loop control unit is operable for the operation of the electric motor via the remote control.

13. The drive device according to claim 1, wherein the remote control includes operating elements for modifying the rotational motor speed and the drive propeller rotary direction and display elements for displaying the current rotational motor speed or the motor performance, as well as the charge state of the energy accumulator.

14. The drive device according to claim 1, wherein, during a reduced charge state of the energy accumulator, the open-loop/closed-loop control unit is able to automatically switch to a modified energizing of the drive, which can result in a lower traveling speed.

15. A method for operating an electromotive drive device for a floatable device, in particular a float tube, wherein the drive device includes a drive, with an electric motor, which is disposed within a flow-optimized hydrodynamically designed housing and outside the housing includes a drive propeller, wherein the electric motor is operated by means of an open-loop/closed-loop control unit in conjunction with a remote control and a power supply module with an energy accumulator, wherein the electronic open-loop/closed-loop control unit includes an information processing unit, which, should the primary or final energy input drop, with sufficient safety for the drive ensures energetic use of the energy provided by the power supply module by reducing the power and while considering a travelled distance or travel time of the floatable device.

16. The method according to claim 15, wherein the information processing unit permanently verifies a rational use of the energy available for the drive and the remote control displays the updated result.

17. The method according to claim 15, wherein the information processing unit calculates an energy-efficient balance of the available energy based on the quantified and/or qualified losses and thereby open-loop and closed-loop controls the motor performance.

18. The method according to claim 15, wherein a maximum travel time of the drive device is calculated based on the available energy balance and the maximum speed.

19. The method according to claim 15, wherein, based on the available energy, the electronic open-loop/closed-loop control unit automatically performs a speed limitation for the drive.

20. The method according to claim 15, wherein the operating conditions of the drive, are displayed in the remote control and can be modified.

21. The method according to claim 15, wherein different transmitting channels can be selected or are modifiable via the remote control.

22. The method according to claim 15, wherein the remote control can modify the speed and direction of rotation of the drive propeller.
